(19) United States
(12) Patent Application Publication
(10) Pub. No.: US 2025/0385242 A1
(43) Pub. Date: Dec. 18, 2025

(54) METHOD FOR PRODUCING SECONDARY BATTERY ELECTRODE

(71) Applicant: TOYOTA JIDOSHA KABUSHIKI KAISHA, Aichi-ken (JP)

(72) Inventors: Hirokazu TAKEUCHI, Toyota-shi (JP); Shinji KOJIMA, Nagoya-shi (JP); Takahiko NAKANO, Nagoya-shi (JP); Yusuke KINTSU, Miyoshi-shi (JP); Takeshi KONDO, Kariya-shi (JP); Hiroyuki ISEKI, Kariya-shi (JP)

(21) Appl. No.: 19/215,338

(22) Filed: May 22, 2025

(30) Foreign Application Priority Data
Jun. 13, 2024 (JP) 2024-096221

(51) Int. Cl. H01M 4/04

(52) U.S. Cl. CPC H01M 4/0471

(57) ABSTRACT

A method for producing a secondary battery electrode includes: drying an electrode paste formed on a surface of a current collector; after drying the electrode paste, baking the electrode paste at a higher temperature than during the drying; and after baking the electrode paste, bending the current collector around a roller surface such that the surface of the current collector on which the electrode paste is formed is disposed at an outer side.

### CROSS-REFERENCE TO RELATED APPLICATION

This application is based on and claims priority under 35 USC 119 from Japanese Patent Application No. 2024-096221, filed on Jun. 13, 2024, the disclosure of which is incorporated by reference herein.

### BACKGROUND

### Technical Field

The present disclosure relates to a method for producing a secondary battery electrode.

### Related Art

In processes to manufacture a secondary battery, such as a lithium-ion secondary battery or the like, a negative electrode paste containing a negative electrode active material and a positive electrode paste containing a positive electrode active material are prepared, and a negative electrode and a positive electrode are produced by coating a negative electrode current collector foil and a positive electrode current collector foil or the like with the respective pastes. Japanese Patent Application Laid-Open (JP-A) No. 2010-257653 describes a method to produce a paste by mixing an active material and a dispersant together to produce a powder mixture, and then kneading the powder mixture while adding water thereto as a dispersion medium (rough kneading process, thick paste process).

JP-A No. 2006-294512 discloses forming multiple cracks by bending an electrode configured by a composite material layer formed on a metal foil in order to manufacture a non-fracturing electrode. The technology of JP-A No. 2006-294512 enables a metal foil to be prevented from fracturing when an electrode is wound onto a shaft as long as the electrode is pre-formed with cracks.

Moreover, JP-A No. H5-41209 discloses a nickel metal hydride secondary battery in which a nickel plate wherein a composite material including a hydrogen storage alloy powder is coated onto the surface thereof is wound up and housed inside a battery can. In the technology of JP-A No. H5-41209, cracks that extend in a direction orthogonal to a winding direction are formed to a composite material layer including the hydrogen storage alloy powder at a specific interval along the winding direction. This accordingly facilitates winding up of the nickel plate formed with the composite material layer.

Furthermore, JP-A No. 2023-178250 discloses an electrode including plural cracks and a manufacturing method thereof. In JP-A No. 2023-178250, the plural cracks are formed in the electrode by adding an additive to an electrode slurry, and evaporating the additive in a drying process. An electrode plate including cracks generated by drying is also disclosed in JP-A No. 2012-248477. The technology of JP-A No. 2012-248477 enables cracks to be formed by controlling the speed of drying of the electrode slurry coated onto a current collector.

### SUMMARY

However, it is difficult to form appropriate cracks in an electrode using technology available hitherto, and a method for forming desired cracks has been demanded. In consideration of the above circumstances, an object of the present disclosure is to provide a method for producing a secondary battery electrode capable of forming appropriate cracks in an electrode.

The present disclosure achieves the above object and encompasses the following.
<1> A method for producing a secondary battery electrode, the method comprising: drying an electrode paste formed on a surface of a current collector; after drying the electrode paste, baking the electrode paste at a higher temperature than during the drying; and after baking the electrode paste, bending the current collector around a roller surface such that the surface of the current collector on which the electrode paste is formed is disposed at an outer side.
<2> The method for producing a secondary battery electrode of claim 1, wherein, when baking the electrode paste, a baking temperature and a baking time satisfy the following equations:

Y≥−8X+1220

100≤X≤150
wherein, in the equations, X is the baking temperature in degrees Celsius and Y is the baking time in minutes.
<3> The method for producing a secondary battery electrode of claim 1, wherein a roller having a roll diameter of 40 mm or greater is employed in the bending.
<4> The method for producing a secondary battery electrode of claim 1, wherein a thickness of the electrode paste formed on the current collector is from 150 μm to 500 μm.
<5> The method for producing a secondary battery electrode of claim 1, wherein, in the bending, cracks are imparted having a depth that is 10% or greater with respect to a thickness of the electrode paste formed on the current collector and that is a depth not reaching the current collector.

The method for producing secondary battery electrode of the present disclosure enables formation of appropriate cracks in an electrode.

### BRIEF DESCRIPTION OF THE DRAWINGS

Exemplary embodiments of the present disclosure will be described in detail based on the following FIGURES, wherein:

FIG. 1 is a characteristic diagram indicating relationships between baking temperatures and baking times of a step of baking as performed on Examples and Comparative Examples.

### DETAILED DESCRIPTION

Description follows regarding exemplary embodiments of the present disclosure. The description merely illustrates examples of exemplary embodiments, and does not limit the range of the present disclosure.

In the present specification a numerical range denoted using “to” indicates a range that includes the respective numerical values proceeding and following “to” as the minimum value and the maximum value thereof.

For a numerical range with a stepwise denotation in the present specification, an upper limit value or a lower limit value for one numerical range may be replaced with an upper limit value or a lower limit value for another stepwise numerical range. Moreover, in numerical ranges listed in the present specification, an upper limit value or a lower limit value of the numerical range may be replaced with a value indicated in an Example.

In the present specification the term “process” not only includes an isolated process, but as long as the intended objective of the process is achieved, the term may also include cases in which another process is unable to be clearly distinguished therefrom.

When an exemplary embodiment is described with reference to the drawings in the present specification, the configuration of the exemplary embodiment is not limited to the configuration illustrated in the drawings. Moreover, the size of members in the drawings is merely schematic, and relative relationships between the sizes of members is not limited thereto.

In the present specification, each component may include plural applicable materials. When reference is made to an amount of each component in a composition in the present exemplary embodiment, then unless explicitly stated otherwise, this means a total amount of plural materials present in the composition when there are plural qualifying materials present in each component in the composition.

A method for producing secondary battery electrode according to the present disclosure (hereinafter simply referred to as a producing method) comprises: drying an electrode paste formed on a surface of a current collector (hereafter, drying step); after drying the electrode paste, baking the electrode paste at a higher temperature than during the drying (hereafter, baking step); and after baking the electrode paste, bending the current collector around a roller surface such that the surface of the current collector on which the electrode paste is formed is disposed at an outer side (hereafter, crack imparting step). The producing method of the present disclosure enables appropriate cracks to be formed in the active material layer by bending the current collector around the roller surface after the baking step, while the face formed with the electrode paste is on the outside thereof. The manufactured electrode is formed with the appropriate cracks in the active material layer, and so this enables sufficient penetration of electrolyte solution into the active material layer. This means that the electrode obtained by the producing method of the present disclosure is, for example, able to be utilized as an optimal electrode for an increased capacity secondary battery having a thicker layer of the active material layer. Note that the producing method of the present disclosure is applicable to both a positive electrode and a negative electrode of a secondary battery.

In the producing method of the present disclosure, in advance of the drying step, a negative electrode paste containing a negative electrode active material and a negative electrode current collector, and also a positive electrode paste containing a positive electrode active material and a positive electrode current collector, are prepared, and the negative electrode paste and the positive electrode paste are respectively coated onto the negative electrode current collector and the positive electrode current collector. Note that in the present disclosure, the negative electrode current collector and the positive electrode current collector are collectively referred to as “current collectors”, and the negative electrode paste and the positive electrode paste are collectively referred to as “electrode pastes”. The method for coating the electrode pastes onto the current collectors is not particularly limited, and examples thereof include a roll coating method, a metal mask printing method, an electrostatic coating method, a die coating method, a spray coating method, a doctor blade method, a gravure coating method, a screen-printing method, and the like.

### Negative Electrode Active Material

The negative electrode active material is not particularly limited, and hitherto known materials may be appropriately applied therefor. Examples of the negative electrode active material include a carbon material. Examples of carbon materials include: a coke such as a petroleum coke, a pitch coke, and a coal coke; a carbon black such as an organic compound carbide, carbon fibers, or acetylene black; and a graphite such as an artificial graphite or a natural graphite. Other than these, a conductive polymer, lithium titanate, silicon, a silicon compound, and the like may also be employed as the negative electrode active material. The materials listed above may be employed singly, or plural of the above materials may be employed in combination, as the negative electrode active material.

An average particle size of the negative electrode active material is not particularly limited and may, for example, be from 1 μm to 100 μm, may be from 5 μm to 80 μm, may be from 10 μm to 50 μm, may be from 10 μm to 30 μm, may be from 10 μm to 25 μm, and may be from 10 μm to 20 μm. Note that the average particle size is a value measured by a usual method using a laser refraction particle size distribution analyzer.

### Negative Electrode Paste

The negative electrode paste is a material of slurry form containing the negative electrode active material. Other than the negative electrode active material, the negative electrode paste also contains a binder, a solvent, and other components.

The binder is not particularly limited and a binder hitherto employed when producing a negative electrode paste may be employed therefor. Examples of the binder include a butadiene rubber (BR), a butyl rubber (IIR), an acrylate-butadiene rubber (ABR), a styrene-butadiene rubber (SBR), polyvinylidene fluoride (PVdF), a poly(vinylidene fluoride-co-hexafluoropropylene) (PVdF-HFP) copolymer, and the like.

The solvent is not particularly limited, and a solvent hitherto employed when producing a negative electrode paste may be employed therefor. The solvent is not particularly limited and examples include, for example, 1, 2, 3, 4-tetrahydronaphthalene, butyl acetate, butyl butyrate, mesitylene, tetralin, heptane, N-methyl-2-pyrrolidone (NMP), and the like.

Examples of the other components include a thickener, a conduction enhancer, and the like. Examples of thickeners include carboxymethyl cellulose, a sodium salt of carboxymethyl cellulose, and the like. Examples of conduction enhancers include a carbon black (acetylene black, thermal black, furnace black, and the like), a conductive oxide, a conductive nitride, and the like.

The negative electrode paste may, for example, be prepared by mixing and kneading components of the above negative electrode active material and the like using a mixer, a ball mill, a super sand mill, a pressure kneader, or the like, and by also adjusting viscosity as required.

### Negative Electrode Current Collector

The negative electrode current collector is not particularly limited, and a negative electrode current collector hitherto employed when producing a negative electrode may be employed therefor. The material of the negative electrode current collector is not particularly limited, and examples thereof include Cu, Ni, Cr, Au, Pt, Ag, Al, Fe, Ti, Zn, Co, stainless steel, and the like. The thickness of the negative electrode current collector is not particularly limited, and may be in a range of from 0.1 μm to 1 mm, for example. Moreover, the negative electrode current collector may be employed in a strip form, such as a foil form, perforated foil form, mesh form, or the like.

### Positive Electrode Active Material

The positive electrode active material is not particularly limited, and a hitherto known material may be appropriately employed therefor. Examples of the positive electrode active material include LiCoO₂, LiNiO₂, LiMnO₂, LiMn₂O₄, Li(NiCoMn)O₂, Li(NiCoAl)O₂, LiFePO₄, and the like. Note that “(NiCoMn) in “Li(NiCoMn)O₂” indicates a total composition ratio of 1 for the bracketed components. The amounts of the individual components may be freely selected as long as the total thereof is 1. Moreover as the positive electrode active material, the Li(NiCoMn)O₂ may, for example, include Li(Ni_{1/3}Co_{1/3}Mn_{1/3})O₂, Li(Ni_{0.5}Co_{0.2}Mn_{0.3})O₂, Li(Ni_{0.8}Co_{0.1}Mn_{0.1})O₂, or the like. Note that positive electrode active material particles may be a Hi-Nickel (positive electrode active material having a high proportion of Ni), and may be ternary positive electrode materials (an NMC (Nickel, Manganese and Cobalt) positive electrode active material).

### Positive Electrode Paste

The positive electrode paste includes the positive electrode active material and is a material of slurry form. The positive electrode paste may also include, other than the positive electrode active material, a binder, a solvent, and other components. Note that similar materials to those described for the negative electrode paste may be employed for the binder, solvent, and other components.

### Positive Electrode Current Collector

The positive electrode current collector is not particularly limited, and may be a foil form, a plate form, a mesh form, a punched metal form, or a foam. Examples of metals configuring the positive electrode current collector include Cu, Ni, Cr, Au, Pt, Ag, Al, Fe, Ti, Zn, Co, stainless steel, and the like. In particular, from the perspective of securing resistance to oxidation the positive electrode current collector may be one including Al.

### Drying Step

In the producing method of the present disclosure, the electrode pastes formed on the current collectors are dried in the drying step. Specifically, the temperature conditions of the drying step may, for example, be from 50 degrees Celsius to 150 degrees Celsius, are preferably from 80 degrees Celsius to 120 degrees Celsius, and are more preferably from 90 degrees Celsius to 110 degrees Celsius. The drying time may be an arbitrary duration, and may be set longer when the drying temperature is low, and may be set shorter when the drying temperature is high. Specifically, the drying temperature and the drying time may, for example, be 12 minutes at 50 degrees Celsius, may be 6 minutes at 80 degrees Celsius, may be 3 minutes at 100 degrees Celsius, and may be 1 minute at 150 degrees Celsius.

### Baking Step

Next, the baking step is performed in the producing method of the present disclosure by baking the electrode pastes at a higher temperature than a temperature in the drying step. Baking at a higher temperature than a temperature in the drying step enables a state to be formed that facilitates formation of appropriate cracks in the active material layer in a crack imparting step, as described in detail later.

The baking step is not particularly limited as long as it is performed at a higher baking temperature than the processing temperature in the drying step described above and is, for example, preferably in a range of from 100 degrees Celsius to 150 degrees Celsius, and more preferably in a range of from 120 degrees Celsius to 140 degrees Celsius. Moreover, the baking time of the baking step is not particularly limited and may be an arbitrary time, and may be set longer when the baking temperature is low, and may be set shorter when the baking temperature is high. For example, the baking time may be from 10 minutes to 1440 minutes, is preferably from 30 minutes to 1440 minutes, is more preferably from 60 minutes to 1440 minutes, is even more preferably from 90 minutes to 1440 minutes, is yet more preferably from 100 minutes to 1440 minutes, is yet more preferably from 120 minutes to 1440 minutes, is yet more preferably from 150 minutes to 1440 minutes, is yet more preferably from 180 minutes to 1440 minutes, is yet more preferably from 200 minutes to 1440 minutes, is yet more preferably from 260 minutes to 1440 minutes, is yet more preferably from 280 minutes to 1440 minutes, and is yet more preferably from 420 minutes to 1440 minutes. Defining the baking temperature and baking time in the baking step as described above enables a state to be formed that facilitates formation of appropriate cracks in the active material layer in the crack imparting step, as described in detail later.

In particular in the baking step of the producing method of the present disclosure, when baking the electrode paste, a baking temperature and a baking time satisfy the following equation Y≥−8X+1220, wherein, in the equation, X is the baking temperature in degrees Celsius and Y is the baking time in minutes.

Note that the value of X in the above equation is 100≤X≤150. The value of X is preferably 110≤X≤150, and is more preferably 120≤X≤150. An upper limit to the range of Y is not particularly limited, and from the perspective of productivity may be 1440 minutes or less, and is preferably 300 minutes or less. Defining the baking temperature and baking time in the baking step so as to satisfy this relationship equation results in a state that facilitates formation of appropriate cracks in the active material layer in the crack imparting step, as described in detail later.

In the producing method of the present disclosure, the thicknesses of the electrode pastes formed on the current collectors after the baking step are not particularly limited, and may, for example, be from 150 μm to 500 μm, are preferably from 200 μm to 500 μm, are more preferably from 250 μm to 500 μm, and are yet more preferably from 300 μm to 500 μm. Setting the thickness of the electrode pastes in these ranges in the producing method of the present disclosure enables formation of appropriate cracks in the active material layer in the crack imparting step as described in detail later.

### Crack Imparting Step

In the producing method of the present disclosure, the crack imparting step is a step of bending the current collectors around a roller surface after the baking step, such that the surface of the current collector on which the electrode paste is formed is disposed at the outer side thereof. The crack imparting step enables formation of appropriate cracks in the active material layer configured by drying the respective electrode paste formed onto the current collector and then baking. Specifically, cracks can be successively formed in the active material layer formed on the current collectors by wrapping the current collectors with a specific wrap angle onto a roller, and conveying the current collectors over the roller surface.

In the crack imparting step, there is no limitation to the roller surface as long as appropriate cracks can be formed in the active material layer and, for example, preferably a roller having a roll diameter of 40 mm or greater is employed. The radius of curvature of the current collector bent around the roller surface is too large when a roller having a roll diameter of less than 40 mm is employed, leading to a concern that cracks might exceed the active material layer and reach the current collector. Using a roller with a roll diameter of 40 mm or greater in the crack imparting step enables the formation of appropriate cracks in the active material layer.

Appropriate cracks in the producing method of the present disclosure means cracks that have a depth of 10% or greater with respect to the thickness of the electrode paste and a depth that does not reach the current collector. In particular cracks in the producing method of the present disclosure preferably have a depth of 30% or greater with respect to the thickness of the electrode paste, more preferably have a depth of 50% or greater with respect thereto, still more preferably have a depth of 70% or greater with respect thereto, and yet more preferably have a depth of 90% or greater with respect thereto. The depth of the cracks is an amount so as not to reach the current collector, and sufficient electrolyte solution penetration can be achieved by being in the above ranges.

### Secondary Battery

The producing method of the present disclosure as described above enables manufacture of an electrode that can be employed in a so-called secondary battery. Such a secondary battery may be configured include the electrodes (a negative electrode and a positive electrode) manufactured as described above, and an electrolyte layer disposed between the negative electrode and the positive electrode. The electrolyte layer in such a secondary battery may be configured without a solid electrolyte and including a liquid electrolyte, and the electrolyte layer may be configured including both a solid electrolyte and a liquid electrolyte. In cases in which the electrolyte layer includes a liquid electrolyte, the electrolyte layer preferably includes a separator that while holding the liquid electrolyte, also prevents contact between the positive electrode and the negative electrode. In cases in which the electrolyte layer includes a solid electrolyte, the electrolyte layer may, in addition to the solid electrolyte, also include an arbitrary binder or the like.

Note that the electrolyte solution is not particularly limited, and examples thereof may include electrolyte solutions employed in nonaqueous electrolyte solution secondary batteries. Examples of the electrolyte solution include, for example, so-called organic electrolyte solutions in which a lithium salt LiClO₄, LiPF₆, LiAsF₆, LiBF₄, LiSO₃CF₃, or the like is dissolved in a nonaqueous solvent configured by ethylene carbonate, propylene carbonate, butylene carbonate, vinylene carbonate, fluoroethylene carbonate, cyclopentanone, sulfolane, 3-methylsulfolane, 2,4-dimethylsulfolane, 3-methyl-1,3-oxazolidin-2-one, γ-butyrolactone, dimethyl carbonate, diethyl carbonate, ethyl methyl carbonate, methylpropyl carbonate, butyl methyl carbonate, ethyl propyl carbonate, butyl ethyl carbonate, dipropyl carbonate, 1,2-dimethoxyethane, tetrahydrofuran, 2-methyltetrahydrofuran, 1,3-dioxolane, methyl acetate, and ethyl acetate, either employed singly or as a mixture of two or more components thereof.

The structure of the secondary battery is not particularly limited, and usually the positive electrode, the negative electrode, and the separator, provided as required, are wound in a flat spiral shape to form a wound type electrode plate group, or are stacked in a flat plate shape to form a stacked electrode plate group, with these electrode plate groups generally configured as a structure encapsulated in a cladding body. Note that the secondary battery of the present disclosure is not particularly limited, and a paper type battery, a button type battery, a coin type battery, a stacked type battery, a cylindrical type battery, a square type battery, or the like may be employed therefor.

The producing method of the present disclosure can be applied to manufacture of an electrode capable of being employed in a so-called bipolar secondary battery. A bipolar secondary battery includes a configuration in which the negative electrode is formed on one surface of a current collector, and the positive electrode is formed on the other surface thereof. In such cases, as described above, the negative electrode can be formed on the one surface of the current collector by performing the drying step, the baking step, and the crack imparting step, and then the positive electrode can be formed on the other surface of the current collector by performing the drying step, the baking step, and the crack imparting step. However, there is no particular limitation to which out of the negative electrode and the positive electrode is formed first, and this may be freely decided in consideration of the coating conditions and the like of the negative electrode and the positive electrode.

### EXAMPLES

Further detailed explanation follows regarding the present disclosure by means of Examples, however the technical scope of the present disclosure is not limited to the following Examples.

### Example 1

In Example 1 an electrode paste is produced as described below. Namely, a paste having a 60% solid content (non-volatile (NV) value) is produced by kneading 90 parts by mass of an active material, one part by mass of a dispersant (carboxymethyl cellulose), 5 parts by mass of a binder (styrene-butadiene rubber), and 4 parts by mass of a conduction enhancer (carbon nano tubes) using a planetary mixer.

Next, the produced electrode paste is coated onto a surface of a 10 μm current collector (material: Cu) so as to achieve a thickness of 450 μm. The electrode paste is then dried at conditions of 100 degrees Celsius and 4 minutes.

After the drying at the above conditions is finished, the baking step is performed on the electrode paste at conditions of 120 degrees Celsius and 280 minutes. Then after that, the crack imparting step is executed by bending the current collector along a roller surface of a φ40 mm roller (at a 70° wrap angle of the current collector on the roller), while the face formed with the electrode paste is on the outside. The current collector is conveyed in this state, and confirmation is made as to whether or not cracks have been generated in the active material layer that was formed by the dried and baked electrode paste. Note that whether or not there were cracks is confirmed using a microscope.

### Example 2

The processes up to the crack imparting step are executed similarly to in the Example 1, except for the baking temperature being 130 degrees Celsius and the baking time being 200 minutes in the baking step, and confirmation is made as to whether cracks have been generated in the active material layer.

### Example 3

The processes up to the crack imparting step are executed similarly to in the Example 1, except for the baking temperature being 140 degrees Celsius and the baking time being 120 minutes in the baking step, and confirmation is made as to whether cracks have been generated in the active material layer.

### Comparative Example 1

The processes up to the crack imparting step are executed similarly to in the Example 1, except for the baking temperature being 120 degrees Celsius and the baking time being 250 minutes in the baking step, and confirmation is made as to whether cracks have been generated in the active material layer.

### Comparative Example 2

The processes up to the crack imparting step are executed similarly to in the Example 1, except for the baking temperature being 130 degrees Celsius and the baking time being 120 minutes in the baking step, and confirmation is made as to whether cracks have been generated in the active material layer.

### Comparative Example 3

The processes up to the crack imparting step are executed similarly to in the Example 1, except for the baking temperature being 130 degrees Celsius and the baking time being 150 minutes in the baking step, and confirmation is made as to whether cracks have been generated in the active material layer.

### Comparative Example 4

The processes up to the crack imparting step are executed similarly to in the Example 1, except for the baking temperature being 140 degrees Celsius and the baking time being 90 minutes in the baking step, and confirmation is made as to whether cracks have been generated in the active material layer.

### Results

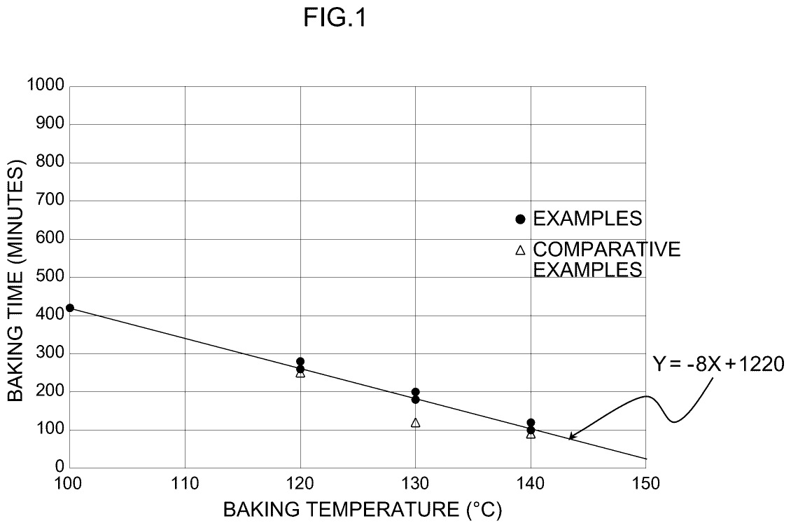

In Example 1 to Example 3, formation is observed of cracks having a depth of 10% or greater with respect to a thickness of the active material layer that is a depth not reaching the current collector. However, in Comparative Example 1 to Comparative Example 4, formation is not observed of cracks having a depth of 10% or greater with respect to a thickness of the active material layer. Results are illustrated in FIG. 1 as a graph plotted with the baking temperatures and baking times of Example 1 to Example 3 and of Comparative Example 1 to Comparative Example 4.

As is apparent from FIG. 1, appropriate cracks can be formed in the active material layer in cases in which the baking temperature and baking time satisfy the relationship equations

Y≥−8X+1220

100≤X≤150

wherein X is the baking temperature in degrees Celsius and Y is the baking time in minutes.

Note that it can be understood from this equation that the baking time should be 420 minutes or greater when the baking temperature is 100 degrees Celsius, the baking time should be 260 minutes or greater when the baking temperature is 120 degrees Celsius, the baking time should be 180 minutes or greater when the baking temperature is 130 degrees Celsius, and the baking time should be 100 minutes or greater when the baking temperature is 140 degrees Celsius.

What is claimed is:

1. A method for producing a secondary battery electrode, the method comprising:
drying an electrode paste formed on a surface of a current collector;
after drying the electrode paste, baking the electrode paste at a higher temperature than during the drying; and
after baking the electrode paste, bending the current collector around a roller surface such that the surface of the current collector on which the electrode paste is formed is disposed at an outer side.

2. The method for producing a secondary battery electrode of claim 1, wherein, when baking the electrode paste, a baking temperature and a baking time satisfy the following equations:
Y≥−8X+1220
100≤X≤150
wherein, in the equations, X is the baking temperature in degrees Celsius and Y is the baking time in minutes.

3. The method for producing a secondary battery electrode of claim 1, wherein a roller having a roll diameter of 40 mm or greater is employed in the bending.

4. The method for producing a secondary battery electrode of claim 1, wherein a thickness of the electrode paste formed on the current collector is from 150 μm to 500 μm.

5. The method for producing a secondary battery electrode of claim 1, wherein, in the bending, cracks are imparted having a depth that is 10% or greater with respect to a thickness of the electrode paste formed on the current collector and that is a depth not reaching the current collector.
